(19) United States
(12) Patent Application Publication
(10) Pub. No.: US 2024/0220372 A1
(43) Pub. Date: Jul. 4, 2024

(54) SYSTEM AND METHOD TO AUTOMATICALLY TAG FILE SYSTEM ASSETS IN PPDM WITH THE MOST OPTIMAL BACKUP MECHANISM FOR CASES WHERE FILE SYSTEMS ARE MOUNTED ON STORAGE VOLUMES FROM A STORAGE ARRAY

(71) Applicant: Dell Products L.P., Round Rock, TX (US)

(72) Inventors: Jayashree Radha, Bangalore (IN); Astha Arora, Bangalore (IN)

(21) Appl. No.: 18/148,095

(22) Filed: Dec. 29, 2022

(51) Int. Cl. G06F 11/14

(52) U.S. Cl. CPC G06F 11/1458; G06F 2201/84

(57) ABSTRACT

One example method includes identifying a data asset for protection, evaluating a configuration of a logical volume group where the data asset is stored, comparing the configuration of the logical volume group with a configuration of a storage array, and based on an outcome of the comparing, selecting a data protection mechanism for the data asset. The data asset may then be tagged with the selected data protection mechanism, and backed up using that selected data protection mechanism.

### FIELD OF THE INVENTION

Embodiments of the present invention generally relate to data protection. More particularly, at least some embodiments of the invention relate to systems, hardware, software, computer-readable media, and methods, for identifying an optimal data backup approach in a given set of circumstances.

### BACKGROUND

Data may be created, stored, and backed up, using a variety of different system configurations. Consider, for example, a case where one or more file systems in an application host are mounted on logical volume groups (LVG) on the application host that map to physical volumes of a storage array, such as the Dell EMC Power Store platform for example. When such file systems needed to be protected, such as by the Dell EMC PowerProtect Data Manager (PPDM) for example, the discovery of the file systems from PPDM will also require a deep discovery to read the details of the underlying storage volumes for each file system.

After the discovery is complete, these file system records are seen as assets along with the underlying storage volume details in PPDM. To protect such file systems, the user currently needs to create a policy for the file systems, and then specify the protection mechanism for the file systems. At present, this selection is implemented manually, by selecting which protection mechanism should be used for protection of the file systems. The user can either choose host-based approach or a storage-direct based approach for the file system protection.

The host-based backup mechanism typically involves using a guest/host-based agent through file based backup (FBB) or block based backups (BBB). The storage-direct based mechanism involves taking a snapshot of the underlying storage volume and directly sending the snapshot to the protection storage, such as the Dell EMC DataDomain platform for example. In some situations, instead of the approach of backing up each of these file systems separately, it might be preferable to take a storage-direct backup of the underlying storage volumes. However, because there are many factors which can influence this decision, choosing the optimal backup approach is not a trivial exercise. Specifically, the user presently has to manually evaluate the various factors, and then determine the most efficient backup mechanism, that is, host-based or storage-direct in this example, for the set of file systems mounted in an LVG. Such manual process is time consuming and cumbersome, and prone to error.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to an embodiment.

FIG. 2 discloses aspects of a first example use case, according to an embodiment.

FIG. 3 discloses aspects of a second example use case, according to an embodiment.

FIG. 4 discloses aspects of a third example use case, according to an embodiment.

FIG. 5 discloses a method according to an embodiment.

FIG. 6 discloses an example computing entity configured to perform any of the disclosed methods, processes, and operations.

### DETAILED DESCRIPTION OF SOME EXAMPLE EMBODIMENTS

Some embodiments of the present invention generally relate to data protection. More particularly, at least some embodiments of the invention relate to systems, hardware, software, computer-readable media, and methods, for identifying an optimal data backup approach in a given set of circumstances.

In general, an embodiment of the invention may automatically determine the most efficient backup mechanism for a file system, and then tag that file system so as to ensure that the file system is backed up using the backup mechanism that was determined to be most efficient. In an embodiment, the determination of the most efficient backup mechanism, and the tagging of the file system, may both be performed automatically without any manual intervention.

One embodiment of the invention may be implemented in connection with filesystems that are mounted on an LVG (logical volume group) that maps to physical volumes of a storage array. Depending upon the analysis of various factors, examples of which are disclosed herein, it may be most efficient to back up the entire volume group (VG) of the storage array, such as with a storage-direct backup process. Alternatively, and depending again upon the outcome of the analysis of various factors, it may be most efficient to implement a host-based backup to backup data of the storage array. Such host-based backups may include, but are not limited to, FBB (file based backups) and BBB (block based backups). As these examples illustrate, a host-based backup may be performed at a more granular level than a storage-direct backup.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment of the invention is that a most efficient backup type for storage array data may be automatically identified and implemented, based on the automatic consideration of various factors. An embodiment may provide for the automatic tagging of storage array data with information identifying the optimal backup type for that storage array data. An embodiment may eliminate the need for manual analysis and evaluation of the aforementioned factors. An embodiment may improve the speed, relative to manual processes, with which an optimum backup type is identified and/or implemented. Various other advantages of some example embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, 10 replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

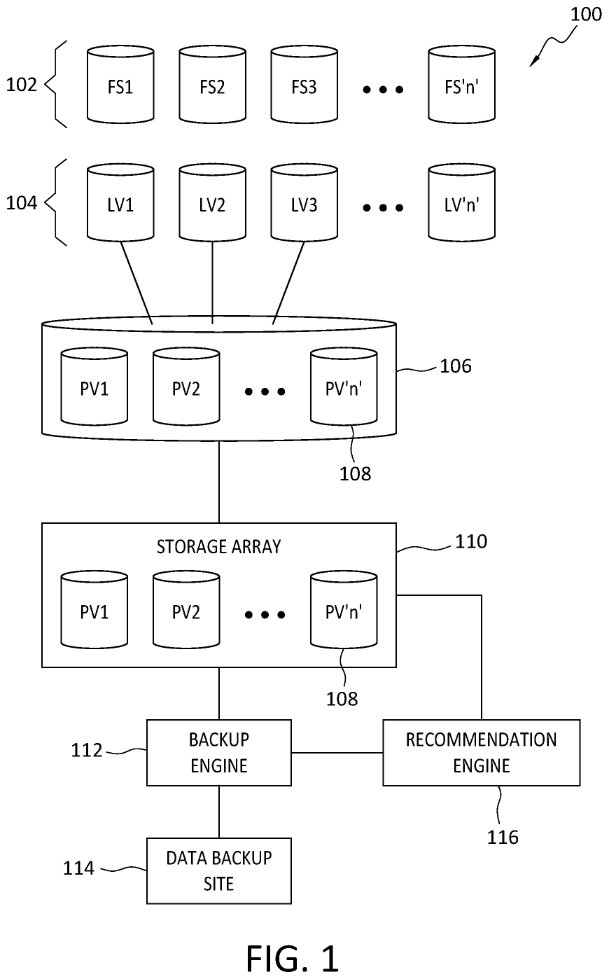

With particular attention now to FIG. 1, one example of an operating environment for embodiments of the invention is denoted generally at 100. In general, the operating environment 100 may comprise any number ‘n’ of filesystems 102, where ‘n’ is any integer equal to or greater than one. The filesystems 102, need not be of any particular type, and may store any number and type(s) of files. A filesystem 102 may be included in, or otherwise associated with, a logical volume (LV) 104. The logical volumes 104 may be of any size, type, and number. For example, there may be any number ‘n’ of LVs 104, where ‘n’ is any integer equal to or greater than one.

In an embodiment, one or more logical volumes 104 may be created from one or more logical volume groups (LVGs) 106 which may, in turn, comprise a virtual grouping of one or more physical volumes (PVs) 108 that reside in a storage array 110, one non-limiting example of which is the Dell EMC Power Store platform. there may be any number ‘n’ of PVs 108, where ‘n’ is any integer equal to or greater than one. In an embodiment, a storage array may comprise thousands, or more, of PVs.

One or more LVGs 106 may be defined, such as by an administrator for example, to respectively embrace any number and/or grouping of PVs 108 of the storage array 110, and the grouping of PVs 108 within an LVG 106 may be modified at any time. As well, an LVG 106 may be defined, or dissolved, at any time.

The storage array 110 may include any type, size, and number of PVs 108. The PVs 108 embraced within any particular LVG 106 may vary from one LVG 106 to another LVG 106. Further, a PV 108 may be embraced within an LVG 106 for one backup operation, and within a different LVG 106 for another backup operation. Thus, the PVs 108 embraced within an LVG 106 may vary over time. Further, one or more LVGs 106 may be defined at any time. One or more LVGs 106 may correspond to different respective groupings of the PVs 108 in the storage array 110. Put another way, a PV 108 may map to a host, or hosts, that host respective groups of one or more FSs 102. In this way, the FSs 102 may, in effect, be stored, or mounted, at the storage array 110.

With continued reference to FIG. 1, the example operating environment 100 may comprise a backup engine 112 that may be operable to perform backup operations on data stored at the storage array 110. The backup engine 112 may comprise a backup application operable to create, and backup, backup datasets to a data backup site 114, one non-limiting example of which is the Dell EMC DataDomain platform. A recommendation engine 116 may be provided that may operate to evaluate various factors, disclosed elsewhere herein, and to recommend, based on that evaluation, a particular backup mechanism for specified data residing in the storage array 110 and embraced within one or more of the LVGs 106. These evaluation and recommendation processes may be performed automatically in response to receipt of information from the backup engine 112 and/or from the storage array 110. The information used by the backup engine 112 for the evaluation and recommendation processes may be pushed to, and/or pulled by, the backup engine 112 from the storage array 110 and/or the backup engine 112. The recommendation engine 116 may operate as a stand-alone entity, or may be incorporated into the backup engine 112. Further discussion of the operation of an example recommendation engine 116 is provided elsewhere herein.

### B. Aspects of Some Example Embodiments

As noted herein, an embodiment of the invention may comprise a method that may automatically determine and tag each file system in a storage array, such as Dell EMC PPDM for example, with the most the efficient backup mechanism, by analyzing various properties. Some example properties or factors that may be considered by one or more embodiments in determining an optimum, or most efficient, backup mechanism for a set of data, may include, but are not limited to:
1. a total size of all the file systems in an LVG;
2. a total size of the physical volumes of the underlying storage array, which is exposed to the LVG;
3. a size of the storage array volume groups that contains the volumes in the LVG—note that for storage-direct backup, if the LVG has volumes that are members of a volume group, the entire volume group in the array must be backed up;
4. a backup time taken by a BBB driver to backup for various different file system sizes—this consideration may apply for synthetic, or incremental backups, as well as full backups, and this information may be obtained, for example, from previous backup analysis data—it is noted also that the parallelism, that is, parallel backup streams, used in that specific host for the BBB backup may be considered so that, in an embodiment, when comparing this data against the empirical data for storage-direct backups, the parallelism factor used in the comparisons should match;
5. a backup time taken for storage direct backup—this information may be obtained from previous backup analysis information and data; and
6. whether or not a user has added all/most of the file systems in one LVG in the same PLC or not.

Following are some examples that illustrate aspects of one or more embodiments of the invention. These examples are provided only by way of illustration and are not intended to limit the scope of the invention in any way.

### B.1 Storage-Direct Backup is Most Efficient—Example 1

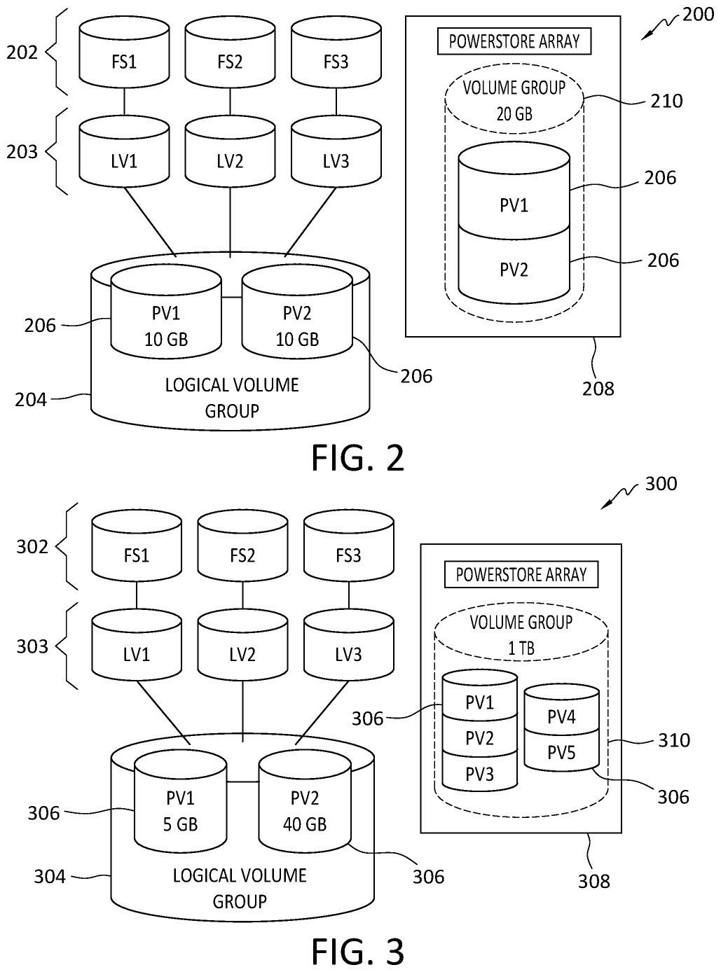

With reference now to FIG. 2, an example configuration 200 is disclosed in which various filesystems 202 may each be associated with a respective logical volume 203 which may represent a respective allocation of storage space in a storage array. The logical volumes 203 may map to an LVG 204, of a host system/device, that has been defined to embrace physical volumes (PV) 206 of a storage array 208. Thus, the filesystems 202 are mounted on the LVG 204 which, in turn, has been defined to embrace one or more PVs 206.

In the particular example of FIG. 2, it can be seen that the storage-direct backup mechanism is most efficient, as between storage-direct and host-based backup mechanisms. Specifically, it can be seen that there are three filesystems 202 mounted on the LVG 204, and the LVG 204 embraces two PVs 206 of the volume group (VG) 210 of the storage array 208. The VG in the storage array 208 also has only two volumes. So, in this case, the size of the LVG 204 is the same as the size of the VG 210 in the storage array 208.

Note that because the LVG 204 is created with the two volumes from the VG 210, a storage-direct backup may require that the entire VG 210 be backed up. This is because it may be the case that the PVs 206 that make up the VG 210 cannot be backed up on an individual basis. As noted, the VG 210 has only two PVs 206. Hence, the total size of the filesystems 202 mounted on the LVG 204—20 GB total (10 GB+10 GB)—is the same, or nearly the same, as the size of the volumes in the LVG, that is, 20 GB.

Thus, in the illustrative example of FIG. 2, the most efficient backup mechanism to protect the filesystem 202 data stored in the storage array 208 is the storage-direct backup mechanism. This is because instead of taking a backup of three different filesystems 202 using a host-based backup such as BBB, it may be simpler and faster to take a single snapshot of the entire underlying storage array 208 VG 210.

### B.2 Host-Based Backup is Most Efficient—Example

With attention next to FIG. 3, an example configuration 300 is disclosed in which various filesystems 302 may each be associated with a respective logical volume 303 which may represent a respective allocation of storage space in a storage array. The logical volumes 303 may map to an LVG 304, of a host system/device, that has been defined to embrace physical volumes (PV) 306 of a storage array 308. Thus, the filesystems 302 are mounted on the LVG 304 which, in turn, has been defined to embrace, or map to, one or more PVs 306.

Particularly, the configuration 300 comprises three filesystems 302 on the LVG 304. In turn, the LVG 304 has two volumes, namely, PV1 and PV2, from a VG 310 of the storage array 308. In an embodiment, and as with the other example storage arrays disclosed herein, the storage array 308 may comprise a Dell ECM PowerStore data storage array, but that is not required. As shown in the illustrative example of FIG. 3, the VG 310 may have a total of five volumes, only two of which, as noted, map to the LVG 304. Thus, the size of the LVG 304 is significantly smaller, in terms of the number of PVs 306, than the size of the VG 310.

Since the two PVs 306 of the LVG 306 belong to a larger group, the VG 310, of volumes, an embodiment may check the composition of the VG 310 in the storage array 308. This check would reveal that not only is the VG 310 bigger, in terms of the number of PVs 306, than the LVG 304, but the VG 310 size (1 TB) is also much bigger, in terms of the total size of all FSs 302 than the total size (5 GB+40 GB, or 45 GB) of all the FSs 302 in the LVG 304.

In this example then, a host-based backup may be a better option since that approach would only require the backup of 45 GB, whereas the storage-direct method would require the entire 1 TB VG 310 to be backed up. Also, the backup time for the host-based approach would likely be much shorter than the backup time for the storage-direct backup of the VG 310.

### B.3 Storage-Direct Backup is Most Efficient—Example 2

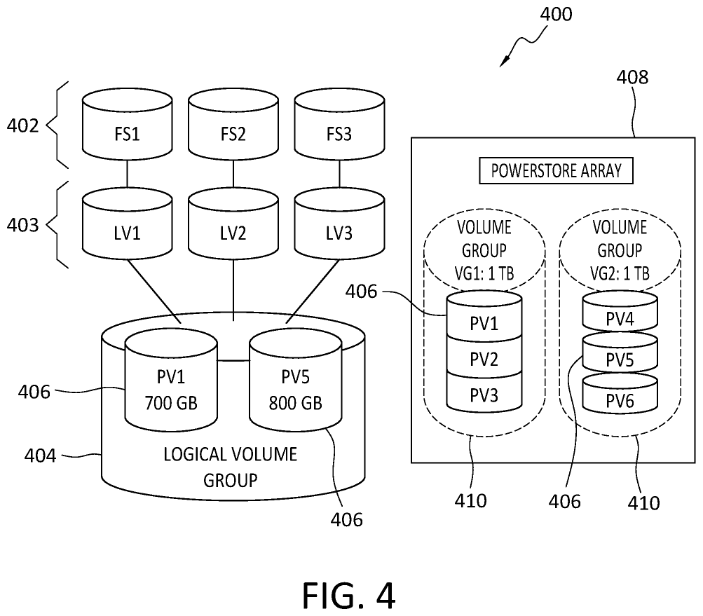

With reference next to FIG. 4, an example configuration 400 is disclosed in which various filesystems 402 may each be associated with a respective logical volume 403 which may represent a respective allocation of storage space in a storage array. The logical volumes 403 may map to an LVG 404, of a host system/device, that has been defined to embrace physical volumes (PV) 406 of a storage array 408. Thus, the filesystems 402 are mounted on the LVG 4204 which, in turn, has been defined to embrace one or more PVs 406, particularly, PV1 and PV5. Note that in this example, PV1 and PV5 are associated with different respective VGs 410 of the storage array 408, namely, VG1 and VG2.

Particularly, the configuration 400 indicates another example use case in which a storage-direct backup mechanism may be more efficient than a host-based backup mechanism. As shown, there are three filesystems 402 on the LVG 404. The LVG 404 includes one PV 406 (PV1) from VG 410 (VG1), and one PV 406 (PV2) from another VG 410 (VG2). In this case, although the number of PVs 406 (6 total) in the VGs 410 is greater than the number of PVs 406 (2 total), the total size (1.5 TB=700 GB+800 GB) of the LVG 404 is almost the same as the combined size (2 TB) of the VGs 410 (VG1+VG2). Thus, performing a storage-direct backup of VG1 and VG2 may be sufficiently efficient in this example use case.

### B.4 Further Discussion

The disclosed examples illustrate that, depending on various factors, the assets, or data, may be automatically tagged with whatever backup mechanism may be most efficient for backing up that asset. Example backup mechanisms include, but are not limited to, host-based backups, and storage-direct backups. Note that as used here, “efficient” may embrace, at least, efficiency in terms of the amount of time needed to perform the backup, and/or the amount of data that is to be backed up. Thus, a relatively faster backup may be considered to be more efficient than a relatively slower backup, and/or a backup that protects relatively less data may be considered to be more efficient than a backup that protects relatively more data. Note that in either of the aforementioned cases, that is, the more efficient backup and the less efficient backup, at least the data specifically tagged for backup will be backed up, although it may be a consequence of the backup mechanism employed that additional data beyond the tagged data may be backed up as well.

In an embodiment, the determination of most efficient backup, and associated tagging of assets, may be implemented, possibly automatically, by a recommendation engine which may operate to help users to decide on the backup technology to be used for particular file system backups. In an embodiment, a user may override a suggestion made by the recommendation engine, and manually select a particular backup mechanism. Note that, in an embodiment, the asset tagging with efficient backup method may enable the grouping of file systems into a single PLC (data protection policy schedule) for which an optimum backup mechanism may be chosen and implemented. In an embodiment, a user may employ a UI, such as the Dell EMC PPDM GUI, to create a data protection policy schedule to enable the protection of particular assets. A data protection policy may comprise, for example, a list of assets to which the policy applies, a schedule according to which the assets will be protected, target storage domain details, and retention periods for the backups of the assets.

### C. Example Methods

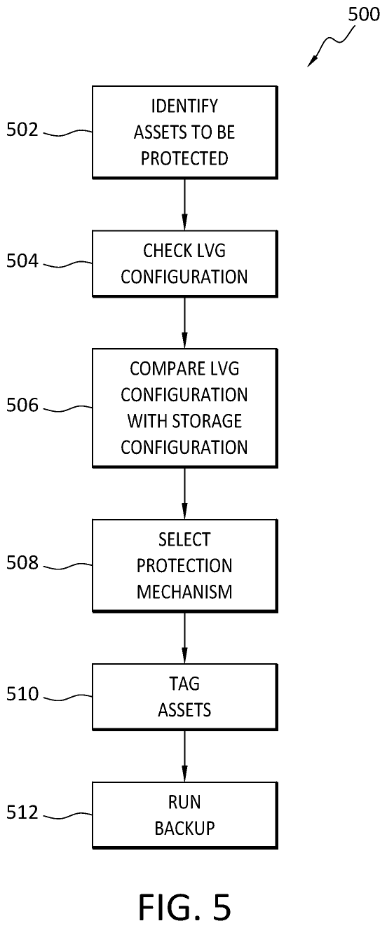

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 5, an example method according to one embodiment of the invention is denoted generally at 500. In an embodiment, the method 500 may be performed by a recommendation engine, which may or may not comprise an element of a backup engine. It is not required, however, that any particular entity, or group of entities, perform the method 500.

The method 500 may begin with the identification of assets 502, such as files, filesystems, or other groupings of data, to be protected. The assets may be specified by a user, or automatically according to criteria such as, but not limited to, the nature (for example, customer data, company financial information, or other information) of the data, and the importance of the data relative to other data (such as low, medium, or high importance). In an embodiment, part or all, of the remainder of the method 500 may be performed automatically in response to the identification 502 of the assets to be protected.

When the data, such as filesystems for example, have been identified 502, a check 504 may be performed concerning the configuration of an LVG on which the identified data resides. The check 504 may comprise, for example, determining, from an evaluation of the LVG, the size and/or number of PVs implied by the identified assets.

After the LVG has been checked 504, the results of the check may be compared 506 with the configuration of a storage array. Note that, prior to the comparing, a check may also be performed of the storage array and that check may be similar to the check performed with regard to the LVG. That is, the storage array check may comprise determining, from an evaluation of the storage array, the size and/or number of VGs, and/or the size and/or number of PVs in each of the VGs.

Based on the outcome of the comparing 506 of the LVG configuration with the storage configuration, an appropriate backup mechanism may then be selected 508 for the assets that were identified 502 earlier. The scope of the invention is not limited to any particular type(s) of backup mechanism. In one embodiment, the selection 508 may be performed as between a host-direct backup mechanism, and a storage-direct backup mechanism, although additional and/or alternative backup mechanisms may also be considered for implementation.

Once a protection mechanism has been selected 508 for the assets that have been identified 502, those assets may then be tagged 510 with a tag indicating the type of backup mechanism to be used to protect the assets. In an embodiment, a tag may also indicate the data protection policy, or policies, applicable to a tagged asset. The tagged asset may then be backed up 512, using the applicable backup mechanism, according to any applicable policy or policies.

### D. Further Example Embodiments

Following are some further example embodiments of the invention. These are presented only by way of example and are not intended to limit the scope of the invention in any way.

Embodiment 1. A method, identifying a data asset for protection; evaluating a configuration of a logical volume group where the data asset is stored; comparing the configuration of the logical volume group with a configuration of a storage array; and based on an outcome of the comparing, selecting a data protection mechanism for the data asset.

Embodiment 2. The method as recited in embodiment 1, wherein the data asset comprises one or more filesystems.

Embodiment 3. The method as recited in any of embodiments 1-2, wherein one or more physical volumes of the storage array map to the logical volume group.

Embodiment 4. The method as recited in any of embodiments 1-3, wherein the data protection mechanism is either a storage-direct data protection mechanism, or a host-direct data protection mechanism.

Embodiment 5. The method as recited in any of embodiments 1-4, wherein the logical volume group and the storage array have one or more physical volumes in common with each other.

Embodiment 6. The method as recited in any of embodiments 1-5, wherein the selected data protection mechanism is a most efficient data protection mechanism of a group of data protection mechanisms from which the data protection mechanism was selected.

Embodiment 7. The method as recited in any of embodiments 1-6, the selected data protection mechanism is faster to perform than would be any other data protection mechanisms which were available for selection.

Embodiment 8. The method as recited in any of embodiments 1-7, the selected data protection mechanism backs up less data than would be backed up any other data protection mechanisms which were available for selection.

Embodiment 9. The method as recited in any of embodiments 1-8, wherein the data asset is tagged with the selected data protection mechanism.

Embodiment 10. The method as recited in any of embodiments 1-9, wherein the data asset is backed up using the selected data protection mechanism.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

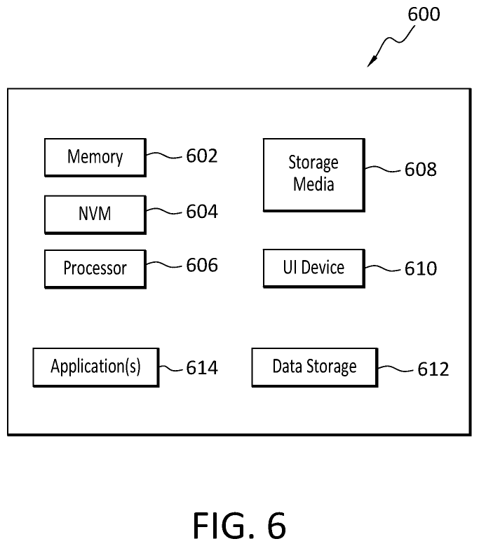

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
identifying a data asset for protection;
evaluating a configuration of a logical volume group where the data asset is stored;
evaluating a configuration of a storage array where the data asset is backed up;
comparing the configuration of the logical volume group with the configuration of the storage array; and
based on an outcome of the comparing, selecting a data protection mechanism for the data asset,
wherein the selected data protection mechanism is either a host-based data protection mechanism or a storage-directed data protection mechanism.

2. The method as recited in claim 1, wherein the data asset comprises one or more file systems.

3. The method as recited in claim 1, wherein one or more physical volumes of the storage array map to the logical volume group.

4. (canceled)

5. The method as recited in claim 1, wherein the logical volume group and the storage array have one or more physical volumes in common with each other.

6. The method as recited in claim 1, wherein the selected data protection mechanism is a most efficient data protection mechanism of a group of data protection mechanisms from which the data protection mechanism was selected.

7. The method as recited in claim 1, the selected data protection mechanism is faster to perform than would be any other data protection mechanisms which were available for selection.

8. The method as recited in claim 1, the selected data protection mechanism backs up less data than would be backed up by any other data protection mechanisms which were available for selection.

9. The method as recited in claim 1, wherein the data asset is tagged with the selected data protection mechanism.

10. The method as recited in claim 1, wherein the data asset is backed up using the selected data protection mechanism.

11. A non-transitory storage medium having stored therein instructions that are executable by one or more hardware processors to perform operations comprising:
identifying a data asset for protection;
evaluating a configuration of a logical volume group where the data asset is stored;
evaluating a configuration of a storage array where the data asset is backed up;
comparing the configuration of the logical volume group with the configuration of the storage array; and
based on an outcome of the comparing, selecting a data protection mechanism for the data asset,
wherein the selected data protection mechanism is either a host-based data protection mechanism or a storage-directed data protection mechanism.

12. The non-transitory storage medium as recited in claim 11, wherein the data asset comprises one or more file systems.

13. The non-transitory storage medium as recited in claim 11, wherein one or more physical volumes of the storage array map to the logical volume group.

14. (canceled)

15. The non-transitory storage medium as recited in claim 11, wherein the logical volume group and the storage array have one or more physical volumes in common with each other.

16. The non-transitory storage medium as recited in claim 11, wherein the selected data protection mechanism is a most efficient data protection mechanism of a group of data protection mechanisms from which the data protection mechanism was selected.

17. The non-transitory storage medium as recited in claim 11, the selected data protection mechanism is faster to perform than would be any other data protection mechanisms which were available for selection.

18. The non-transitory storage medium as recited in claim 11, the selected data protection mechanism backs up less data than would be backed up by any other data protection mechanisms which were available for selection.

19. The non-transitory storage medium as recited in claim 11, wherein the data asset is tagged with the selected data protection mechanism.

20. The non-transitory storage medium as recited in claim 11, wherein the data asset is backed up using the selected data protection mechanism.

21. The method as recited in claim 1, wherein each of the configuration of the logical volume group or the storage array includes a total size of all file systems in the logical volume group, a total size of physical volumes of the storage array, a size of the storage array volume groups, a backup time taken by the host-based data protection mechanism, a backup time taken for the storage-directed data protection mechanism, or whether or not a user has added most of file systems in one logical volume group in a single data protection policy schedule.

22. The method as recited in claim 1, wherein, wherein the host-based data protection mechanism uses a guest/host-based agent through file or block based backups, and
wherein the storage-directed data protection mechanism involves a snapshot of the storage volume.
